(19) United States
(12) Patent Application Publication
(10) Pub. No.: US 2013/0168319 A1
(43) Pub. Date: Jul. 4, 2013

(54) TREATMENT OF WASTE WATER CONTAINING FLUORINATED ACIDS OR THE SALTS THEREOF

(71) Applicants: Eike Gabel, Bergisch Gladbach (DE); Helmut Lahr, Odenthal (DE); Thomas Gruber, Krefeld (DE); Stefan Neumann, Leverkusen (DE); Uwe Böger, Leverkusen (DE); Axel Boddenberg, Wermelskirchen (DE)

(72) Inventors: Eike Gabel, Bergisch Gladbach (DE); Helmut Lahr, Odenthal (DE); Thomas Gruber, Krefeld (DE); Stefan Neumann, Leverkusen (DE); Uwe Böger, Leverkusen (DE); Axel Boddenberg, Wermelskirchen (DE)

(73) Assignee: LANXESS DEUTSCHLAND GMBH, Leverkusen (DE)

(21) Appl. No.: 13/577,325

(22) PCT Filed: Feb. 15, 2011
(86) PCT No.: PCT/EP2011/052204

§ 371 Date: Mar. 21, 2013

(30) Foreign Application Priority Data
Feb. 18, 2010 (EP) 10001656.7

(51) Int. Cl. C02F 1/42

(52) U.S. Cl. CPC C02F 1/42
USPC 210/670; 210/683; 521/25

(57) ABSTRACT

The invention relates to a method of separating off fluorinated acids, in particular perfluorocarboxylic acids and perfluorosulphonic acids or salts thereof, from dilute aqueous solutions with the help of anion exchangers.

The invention relates to a method of separating off fluorinated acids, in particular perfluorocarboxylic acids and perfluorosulphonic acids or salts thereof, from dilute aqueous solutions with the help of anion exchangers.

Fluorinated acids, such as in particular perfluorocarboxylic acids (PFCA) and perfluorosulphonic acids (PFSA), are often used as surfactants or as preproducts for fluorinating agents such as, for example, perfluorobutanesulphonyl fluoride and are produced industrially typically by electrofluorination or more rarely by the telomerization of fluorinated monomers, each of which is associated with high technical complexity.

During the electrofluorination for example for producing perfluorosulphonic acids, as a result of waste-gas purification and product purification, typically dilute aqueous solutions of perfluorosulphonic acids are produced as wastewaters, which can also comprise perfluorocarboxylic acids for example from oxidative secondary reactions, and also residues of the hydrogen fluoride used.

The advantageous application properties of the fluorinated acids are accompanied by the disadvantage that they are biodegradable only with difficulty and can therefore accumulate in the food chain. For this reason, in various jurisdictions, there are endeavours and measures to make the discharges into the environment the subject of legal stipulations (in the EU for example by the guideline 2006/122/EC).

For this reason too, there has been no lack of attempts to recover, or at least to remove, fluorinated acids from dilute aqueous solutions such as, for example, wastewaters described above.

U.S. Pat. No. 5,442,097 discloses a process for the recovery of fluorinated carboxylic acids in utilizable fluorinated carboxylic acid from these materials in aqueous solutions with a sufficiently strong acid, reacting this fluorinated carboxylic acid with a suitable alcohol and distilling off the ester formed. The starting material which can be used here is a polymerization liquor, in particular from the so-called emulsion polymerization, in which fluoropolymers are produced in the form of colloidal particles in the presence of relatively large amounts of fluorine-containing carboxylic acids as surfactants. The recovery process should have proven very worthwhile, but presupposes a relatively high concentration of fluorinated carboxylic acid in the starting material.

DE-A-20 44 986 discloses a method of obtaining perfluorocarboxylic acids from dilute aqueous solutions which comprises bringing the dilute, aqueous solution of the perfluorocarboxylic acids into adsorption contact with a weakly basic anion exchanger resin and, as a result, adsorbing the perfluorocarboxylic acid present in the solution onto the anion exchanger resin, eluting the anion exchanger resin with an aqueous ammonia solution, thereby transferring the adsorbed perfluorocarboxylic acid into the eluent and finally obtaining the acid from the eluate. However, for complete elution, relatively large amounts of dilute ammonia solution are required and, moreover, this method is very time-consuming.

The aforementioned disadvantages are said to be overcome by the method, known from U.S. Pat. No. 4,282,162, for the elution of fluorinated emulsifier acids adsorbed to basic anion exchangers in which the elution of the adsorbed fluorinated emulsifier acid from the anion exchanger is undertaken with a mixture of dilute mineral acid and an organic solvent. During this method, the regeneration of the exchanger resin is effected at the same time through the use of the acid.

Finally, DE 198 24 614 A discloses a method in which firstly finely divided solids and/or fractions that can be converted into solids are removed from the wastewater, then fluorinated acids are bonded to an anion exchanger resin and the fluorinated acids are eluted from this.

However, a disadvantage of the aforementioned methods is that the selectivity of the ion exchanger and thus the efficiency of the separation is only inadequate.

It was therefore the object to provide a method which permits as complete as possible a separation of fluorinated acids from dilute aqueous solutions.

A method of separating off fluorinated acids or salts thereof from their dilute aqueous solutions by contacting aforementioned solutions with an anion exchanger has now been found, which is characterized in that the anion exchangers used are those which are present at least partially in the fluoride form.

The scope of the invention encompasses the radical definitions and/or parameters listed above and below, in general terms or within preferred ranges, including in any desired combination with one another.

Within the context of the invention, the term “dilute aqueous solution” means a liquid medium with a solids fraction of less than 5% by weight, preferably less than 1% by weight and particularly preferably less than 0.05% by weight, which comprises at least 80% by weight, preferably at least 90% by weight, of water, and also at least one fluorinated acid or at least one salt of a fluorinated acid, the total amount of fluorinated acid or salts of fluorinated acids being 0.0005 to 5% by weight, preferably 0.0005 to 2% by weight, particularly preferably 0.005 to 1% by weight and very particularly preferably 0.01 to 0.5% by weight.

Within the context of the invention, fluorinated acids are those which have 1 to 30 carbon atoms and at least one fluorine atom and, under standard conditions, have a pKa of 6.0 or less, preferably of 4.0 or less, particularly preferably of 3.2 or less. Here, one or more, preferably one, acid group may be present, the pKa value stated referring in the case of polyhydric acids to the first deprotonation stage in each case.

Within the context of the invention, preferred fluorinated acids are perfluorocarboxylic acids of the formula (I) and perfluorosulphonic acids of the formula (II)

F—(CF₂)ₙCOOH (I)

F—(CF₂)ₘSO₂OH (II)

in which
n and m are in each case an integer from 1 to 24, preferably 1 to 12 and particularly preferably 4 to 8 and very particularly preferably 4.

The definitions, ranges and preferred ranges given above for the fluorinated acids apply entirely analogously to the corresponding salts of fluorinated acids. A salt of a fluorinated acid is to be understood as meaning a compound in which the acid proton is replaced by another cation, such as, for example, a metal cation or ammonium ion.

Anion exchangers which are present at least partially in fluoride form are those to which fluoride anions are bonded via ionic interactions. Suitable anion exchangers include strongly basic and weakly basic anion exchangers, strongly basic anion exchangers being understood in particular as meaning those which contain quaternary ammonium ions, and weakly basic ones being understood as meaning those which contain primary, secondary or tertiary amine groups or their corresponding ammonium ions as structural element.

Preferred strongly basic anion exchangers are those which have the structural element of the formula (III)

—N⁺(R¹R²R³)X⁻ (III)

in which
R¹, R² and R³, in each case independently of one another, are C₁-C₁₂-alkyl which may be either further unsubstituted, monosubstituted or polysubstituted by hydroxy or C₁-C₄-alkoxy, or two of the radicals together are C₂-C₁₂-alkylene, which may be mono- or polysubstituted by hydroxy or C₁-C₄-alkoxy and
X⁻ is an anion which, in one preferred embodiment, is selected from the group fluoride, chloride, bromide, hydroxide, nitrate, hydrogensulphate and sulphate.

Preferred weakly basic anion exchangers are those which have the structural element of the formula (IV) or the structural element of the formula (V) or have structural elements of the formulae (IV) and (V)

—N⁺(R⁴R⁵R⁶)X⁻ (IV)

in which
R⁴, R⁵ and R⁶, in each case independently of one another, are hydrogen or C₁-C₁₂-alkyl, which may be either further unsubstituted, monosubstituted or polysubstituted by hydroxy or C₁-C₄-alkoxy, or, if two of the radicals R⁴,
   R⁵ and R⁶, are not hydrogen, these radicals together are C₂-C₁₂-alkylene which may be mono- or polysubstituted by hydroxy or C₁-C₄-alkoxy and
   where, however, at least one, preferably one or two, particularly preferably one, of the radicals R⁴, R⁵ and R⁶ is hydrogen and
X— is an anion which, in one preferred embodiment, is selected from the group fluoride, chloride, bromide, hydroxide, nitrate, hydrogensulphate and sulphate

—N(R⁷R⁸) (V)

in which
R⁷ and R⁸, in each case independently of one another, are hydrogen or C₁-C₁₂-alkyl, which may be either further unsubstituted, monosubstituted or polysubstituted by hydroxy or C₁-C₄-alkoxy, or, if two of the radicals R⁷ and R⁸ are not hydrogen, these radicals together are C₂-C₁₂-alkylene which may be mono- or polysubstituted by hydroxy or C₁-C₄-alkoxy.

In principle, suitable ion exchangers also include those which have the structural elements of the formulae (III) and (IV) and/or (V).

Wealdy basic ion exchangers are preferred, with yet further preference being given to those which have the structural element of the formulae (IV) and/or (V).

A particularly preferred anion exchanger is Lewatit® MP 62 from Lanxess Deutschland GmbH, a weakly basic, macroporous anion exchanger with tertiary amino groups.

According to the invention, the anion exchanger is present at least partially in fluoride form, i.e. fluoride anions are bonded to the anion exchangers via ionic interactions.

Typically, this is achieved by
A) bringing the anion exchangers used into contact with hydrogen fluoride and/or salts containing fluoride anions, before bringing them into contact with the dilute aqueous solutions of the fluorinated acids or their salts, in such a way that, after the bringing into contact, at least some, preferably at least 80%, particularly preferably at least 90%, of the anions bonded by ionic interactions are fluoride anions
   and/or
B) the dilute aqueous solutions further comprising hydrogen fluoride and/or fluoride anions or, prior to bringing them into contact with the anion exchanger, admixing them with hydrogen fluoride and/or salts containing fluoride anions.
   In this case, the content of fluorinated acids or their salts in the dilute aqueous solution is preferably 0.05 to 10% by weight of hydrogen fluoride or salts containing fluoride anions, relative to and calculated on the basis of hydrogen fluoride.

In one exemplary embodiment, the pH of the dilute aqueous solution of fluorinated acids or salts thereof is from 1.0 to 10.0, preferably 2.0 to 10.0, particularly preferably 3.0 to 9.0 and very particularly preferably 3.0 to 8.0, in each case under standard conditions.

When using weakly basic anion exchangers, the pH is preferably 3.5 to 7.5, preferably 5.5 to 7.0 and particularly preferably 6.0 to 6.8, under standard conditions.

The bringing into contact of the dilute aqueous solutions of fluorinated acids or their salts with the anion exchanger can take place in a manner known per se, it being possible, for example, to arrange the anion exchangers in customary apparatuses such as tubes or columns through which the dilute aqueous solutions flow.

The wastewater remaining after the dilute aqueous solutions of fluorinated acids or their salts have been brought into contact with the anion exchanger typically has a significantly lower content of fluorinated acids or their salts than before the bringing into contact, the process preferably being controlled such that at least 80% by weight of the fluorinated acids or their salts present in the dilute aqueous solutions used are bonded by the anion exchanger, preferably 90% by weight.

For example, this is ensured when the anion exchanger, after through-flow, is regenerated or replaced by bringing it into contact with a certain amount of dilute aqueous solution.

The capacity of the anion exchanger for fluorinated acids or salts thereof depends inter alia on the selected type of anion exchanger and type and content of the dilute aqueous solutions of fluorinated acids or salts thereof used. However, this can be ascertained in simple preliminary experiments by a person skilled in the art in a manner known per se.

The wastewater obtained after the bringing into contact with the anion exchanger comprises hydrogen fluoride and/or fluoride anions which can preferably be at least partially precipitated in a further step by adding calcium salts in the form of calcium fluoride.

If necessary, the wastewater can be brought into contact with customary adsorbents such as, for example, activated carbon, to remove any possible residual fractions of fluorinated acids or their salts.

Variant A) is particularly preferred. Consequently, the invention further encompasses a method of conditioning anion exchangers by bringing them into contact with an acid, where the acid is hydrofluoric acid, and also the use of hydrofluoric acid for the conditioning of anion exchangers.

The preferred ranges specified above for anion exchangers apply here in an identical manner.

The content of hydrogen fluoride in the hydrofluoric acid can be for example 0.1 to 38% by weight, preferably 1 to 25% by weight and particularly preferably 2.5 to 10% by weight, for the conditioning.

The eluate typically comprises fluorinated acids or salts thereof in a form which is enriched compared to the dilute aqueous solutions, and also hydrogen fluoride. The enrichment can be for example 10- to 200-fold, preferably 20- to 50-fold, based on the content of the fluorinated acids and salts thereof.

The fluorinated acids or salts thereof can, optionally after esterification, be extracted from the eluate for example using an organic solvent, or the enriched eluate can be disposed of for example by wastewater incineration.

The method according to the invention is suitable in particular for dilute aqueous solutions comprising fluorinated acids and/or salts thereof which originate from the production of perfluorosulphonic acids by electrofluorination.

During such electrofluorinations for example for producing perfluorosulphonic acids, as a result of waste-gas purification and product purification, typically dilute aqueous solutions of perfluorosulphonic acids are produced as wastewaters, which may also comprise perfluorocarboxylic acids, for example from oxidative secondary reactions, and also remains of the hydrogen fluoride used.

Typically, such dilute aqueous solutions comprise acids of the formula (I) and acids of the formula (ID in which m=(n+1) in amounts as have been stated above, and also hydrogen fluoride or fluoride, the hydrogen fluoride or fluoride typically being present in amounts of 1 to 100 g/l, relative to and calculated on the basis of hydrogen fluoride.

The aforementioned dilute aqueous solutions can also comprise sulphonyl fluoride and typically have a pH of 0 to 3.5.

For the hydrolysis of sulphonyl fluoride and optional separation off of hydrogen fluoride, it is preferred to firstly adjust the pH of the dilute aqueous solutions to 10 to 14, preferably 11 to 13, by adding basic salts, to separate off any precipitated salts and to adjust the dilute aqueous solution obtained in this way to a pH as has been defined above.

The separation of precipitated calcium fluoride can take place in a manner known per se, for example by filtration, if necessary using a filtration auxiliary, by decantation, centrifugation or sedimentation.

Basic salts are, for example, carbonates and hydroxides of sodium, potassium and calcium, or mixtures thereof.

The advantage of the invention is the superior separation off of fluorinated acids or salts thereof from dilute aqueous solutions compared to the prior art.

### EXAMPLES

### Example 1

### Sample Preparation

Wastewaters from the production of perfluorobutanesulphonic acid were collected and adjusted to a pH of 6.2 using hydrofluoric acid.

A dilute aqueous solution comprising 70 mg/l of perfluorobutanoic acid or perfluorobutanoate (PFBA), 1290 mg/l of perfluorobutanesulphonic acid or perfluorobutanesulphonate (PFBS), in each case calculated on the basis of the free acid, and 1.5 g/l of hydrogen fluoride or fluoride calculated on the basis of fluoride was obtained.

### Example 2

### Adsorption

About 100 ml of the weakly basic anion exchanger Lewatit® MP 62 from Lanxess Deutschland GmbH were placed into a cylindrical glass column provided with glass frit (length 150 cm, diameter 12 mm) and rinsed with water. To condition the anion exchanger, conditioning was carried out with 3 bed volumes (i.e. 300 ml) of a 4% strength by weight hydrofluoric acid solution over a period of 45 minutes at a linear rate.

The dilute aqueous solution from Example 1 was fed over the anion exchanger at a rate of 4 bed volumes (i.e. 400 ml) per hour at a linear rate, and the concentration of perfluorobutanesulphonic acid or its salts (PFBS) or the concentration of perfluorobutanoic acid or its salts (PFBA) in the discharge was determined at intervals of 2.5 hours by HPLC-MS. The results are given in Table 1:

Bed volume 100 ml MP-62

| Wastewater | | PFBA | PFBA | PFBS | PFBS |
|---|---|---|---|---|---|
| [ml] | BV | [mg/l] | Reduction [%] | [mg/l] | Reduction [%] |
| 0 | | 70 | | 1290 | |
| 1000 | 10 | <0.003 | 100% | <0.003 | 100% |
| 2000 | 20 | <0.003 | 100% | <0.003 | 100% |
| 3000 | 30 | <0.003 | 100% | <0.003 | 100% |
| 4000 | 40 | 0.118 | 99.9% | <0.003 | 100% |
| 5000 | 50 | 5.9 | 91.6% | 0.004 | 100% |
| 6000 | 60 | 12.1 | 82.7% | <0.003 | 100% |
| 7000 | 70 | 79.7 | 0.0% | <0.003 | 100% |
| 8000 | 80 | 141 | | <0.003 | 100% |
| 9000 | 90 | 248 | | <0.003 | 100% |
| 9600 | 96 | 347 | | <0.003 | 100% |

BV = Bed volumes

The example shows that the adsorption of perfluorobutanesulphonic acid or its salts (PFBS) proceeds completely for longer than for perfluorobutanoic acid or its salts (PFBA). From the results found, it can be deduced that an adsorption of more than 90% by weight on fluorinated acids is achieved overall for the entire duration.

### Example 3

### Elution

The anion exchanger laden as in Example 2 was regenerated over a period of 30 minutes using in total 200 ml of a 7% strength by weight sodium hydroxide solution, and the anion exchanger was then washed over a period of 60 minutes using a total of 400 ml of water, the steps each taking place at a linear rate.

The eluates were combined and disposed of.

### Example 4

### Conditioning

The anion exchanger regenerated as in Example 3 was conditioned analogously to Example 2 with 3 bed volumes (i.e. 300 ml) of a 4% strength by weight hydrofluoric acid solution over a period of 45 minutes at a linear rate and reused for an adsorption experiment as in Example 3.

The values obtained remained unchanged.

What is claimed is:

1. Method of separating off fluorinated acids or their salts from dilute aqueous solutions by contacting aforementioned solutions with an anion exchanger, characterized in that the anion exchangers used are those which are present at least partially in the fluoride form.

2. Method according to claim 1, characterized in that the dilute aqueous solutions comprise at least one fluorinated acid or at least one salt of a fluorinated acid, the total amount of fluorinated acid or salts of fluorinated acids being 0.0005 to 5% by weight, preferably 0.0005 to 2% by weight.

3. Method according to claim 1 or 2, characterized in that the dilute aqueous solutions comprise perfluorocarboxylic acids of the formula (I) and/or perfluorosulphonic acids of the formula (II) or salts thereof
F—(CF₂)ₙCOOH (I)
F—(CF₂)ₘSO₂OH (H)
in which
n and m are in each case an integer from 1 to 24.

4. Method according to claim 3, characterized in that the dilute aqueous solutions comprise perfluorocarboxylic acids of the formula (I) and perfluorosulphonic acids of the formula (II), in which n and m are in each case an integer from 1 to 24 and m=(n+1).

5. Method according to one of claims 1 to 4, characterized in that the dilute aqueous solutions further comprise hydrogen fluoride or fluoride in an amount of from 0.1 to 10% by weight, relative to and calculated on the basis of fluoride.

6. Method according to one of claims 1 to 5, characterized in that the anion exchangers used ate those which have the structural element of the formula (IV) or the structural element of the formula (V) or have structural elements of the formulae (IV) and (V)
—N⁺(R⁴R⁵R⁶)X⁻ (IV)
in which
R⁴, R⁵ and R⁶, in each case independently of one another, are hydrogen or C₁-C₁₂-alkyl, which may be either further unsubstituted, monosubstituted or polysubstituted by hydroxy or C₁-C₄-alkoxy, or, if two of the radicals R⁴, R⁵ and R⁶ are not hydrogen, these radicals together are C₂-C₁₂-alkylene, which may be unsubstituted, monosubstituted or polysubstituted by hydroxy or C₁-C₄-alkoxy and
where, however, at least one of the radicals R⁴, R⁵ and R⁶ is hydrogen and
X— is an anion
—N(R⁷R⁸) (V)
in which
R⁷ and R⁸, in each case independently of one another, are hydrogen or C₁-C₁₂-alkyl which may either be further unsubstituted, monosubstituted or polysubstituted by hydroxy or C₁-C₄-alkoxy, or, if two of the radicals R⁷ and R⁸ are not hydrogen, these radicals together are C₂-C₁₂-alkylene which can be unsubstituted, monosubstituted or polysubstituted by hydroxy or C₁-C₄-alkoxy.

7. Method according to claim 6, characterized in that the pH of the dilute aqueous solution is 3.5 to 7.5.

8. Method according to one of claims 1 to 7, characterized in that the anion exchanger used is regenerated and reused.

9. Method of conditioning anion exchangers by bringing the anion exchanger into contact with an acid, characterized in that the acid is hydrofluoric acid.

10. Use of anion exchangers in a method according to one of claims 1 to 9.

11. Use of hydrofluoric acid for conditioning anion exchangers.
